(19) United States
(12) Patent Application Publication
(10) Pub. No.: US 2026/0163276 A1
(43) Pub. Date: Jun. 11, 2026

(54) ELECTRONIC APPARATUS

(71) Applicant: CANON KABUSHIKI KAISHA, Tokyo (JP)

(72) Inventor: DAISUKE TODA, Kanagawa (JP)

(21) Appl. No.: 19/181,634

(22) Filed: Apr. 17, 2025

(30) Foreign Application Priority Data
Jun. 6, 2024 (JP) 2024-091959

(51) Int. Cl. H01R 12/91

(52) U.S. Cl. CPC H01R 12/91

(57) ABSTRACT

An electronic apparatus includes a first substrate including a first connector and fixed to a first fixed member, and a second substrate including a second connector connected to the first connector and a terminal connectable to an external device, and fixed to a second fixed member different from the first fixed member so that the second substrate is parallel to a substrate surface of the first substrate. The terminal overlaps the first substrate in a direction orthogonal to the substrate surface.

### BACKGROUND

### Technical Field

The present disclosure relates to an electronic apparatus having an external connection terminal.

### Description of Related Art

In the conventional electronic apparatus, a substrate mounted with an external connection terminal that is electrically connected to an external device is positioned and fixed inside it. Japanese Patent No. 5518037 discloses an electronic apparatus that can accurately position an external connection terminal and a battery connector mounted on a main substrate.

However, in a case where the electronic apparatus disclosed in Japanese Patent No. 5518037 is mounted with a large external connection terminal such as an HDMI type-A terminal, which is a standard type of HDMI (registered trademark) terminal, the size of the substrate increases, especially in the height direction.

### SUMMARY

An electronic apparatus according to one aspect of the disclosure includes a first substrate including a first connector and fixed to a first fixed member, and a second substrate including a second connector connected to the first connector and a terminal connectable to an external device, and the second substrate being fixed to a second fixed member different from the first fixed member so that the second substrate is parallel to a substrate surface of the first substrate. The terminal overlaps the first substrate in a direction orthogonal to the substrate surface.

Further features of various embodiments of the disclosure will become apparent from the following description of embodiments with reference to the attached drawings.

### BRIEF DESCRIPTION OF THE DRAWINGS

FIGS. 1A and 1B are perspective views of an image pickup apparatus, which is an example electronic apparatus according to one embodiment of the present disclosure.

FIGS. 2A and 2B illustrate principal parts of the image pickup apparatus.

FIG. 3 is a perspective view of a connection cable.

FIGS. 4A, 4B, and 4C explain the image pickup apparatus.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

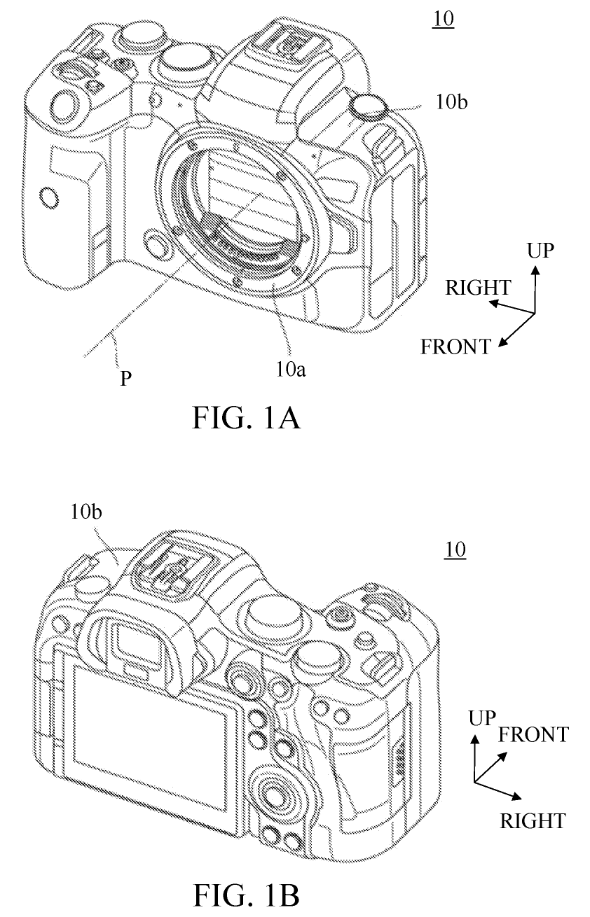

FIG. 1 is a perspective view of an image pickup apparatus 10, which is an example electronic apparatus according to one embodiment of the present disclosure. This embodiment will discuss an example in which the present disclosure is applied to an image pickup apparatus, but is not limited to this example. This embodiment is also applicable to other electronic apparatuses such as a personal digital assistant (PDA) or a mobile phone.

In the following description, an up-down direction, a front-rear direction, and a left-right direction are defined based on a direction when viewed from a user (photographer) facing the rear surface of the image pickup apparatus 10.

FIG. 1A is a perspective view of the image pickup apparatus 10 viewed from the front side, and FIG. 1B is a perspective view of the image pickup apparatus 10 viewed from the rear side. The image pickup apparatus 10 includes a mount 10a and an exterior part 10b. An interchangeable lens (lens apparatus) (not shown) can be attached to the mount 10a. An axis passing through the center of the mount 10a approximately coincides with an optical axis P (see an alternate long and short dash line) of the imaging optical system of the interchangeable lens, that is, an imaging optical axis. The exterior part 10b includes a plurality of members. In this embodiment, the image pickup apparatus 10 is a lens interchangeable type camera to which an interchangeable lens can be attached, but it may be a camera in which the camera body and the lens unit are integrated.

The figures that are used in the following description will illustrate parts necessary for understanding the embodiment, and will omit unnecessary parts.

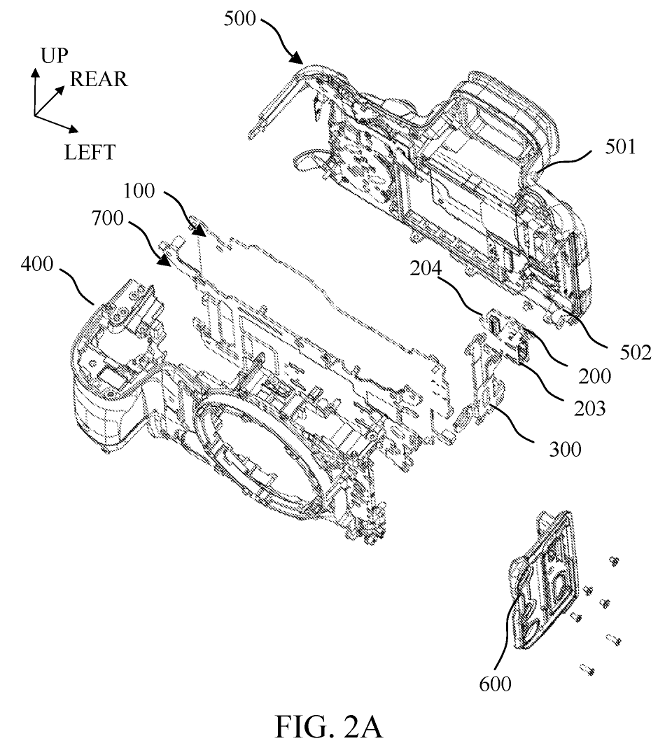

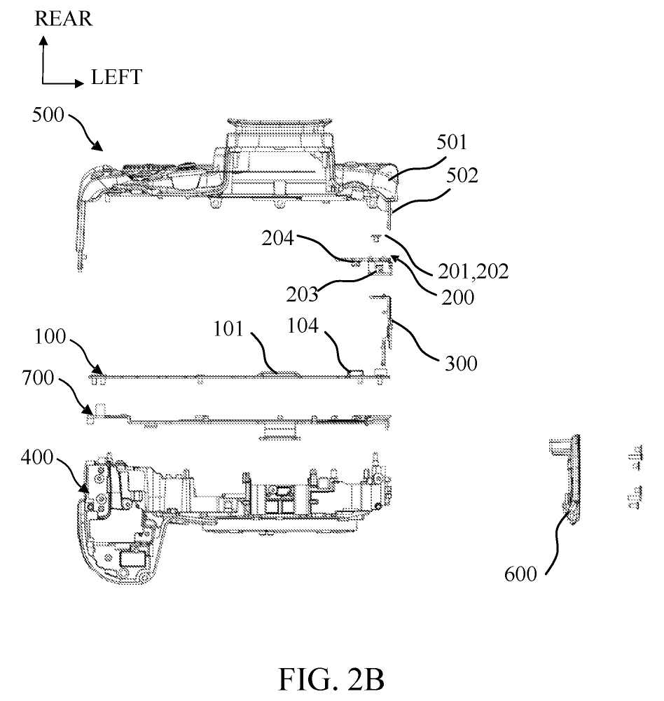

FIGS. 2A and 2B illustrate the principal part of the image pickup apparatus 10. FIG. 2A is an exploded view of the image pickup apparatus 10 viewed from the diagonal front side, and FIG. 2B is an exploded view of the image pickup apparatus 10 viewed from above. The image pickup apparatus 10 includes a control substrate (first substrate) 100, an external terminal substrate (second substrate) 200, a holding metal plate (second fixed member) 300, a base member (first fixed member) 400, a rear cover unit 500, a side cover (exterior member) 600, and a heat radiating plate 700. The control substrate 100 and the holding metal plate 300 are positioned on and fixed to the base member 400. The rear cover unit 500 includes a rear cover 501, and constitutes the exterior part 10b together with the side cover 600.

The control substrate 100 is mounted with a control IC 101 for controlling an image signal, and a connector 104. Various electronic components such as chip resistors, ceramic capacitors, inductors, and transistors are mounted on the control substrate 100. The control substrate 100 is positioned on the base member 400 and fixed by fastening with screws. The heat radiating plate 700 is disposed on the front side of the control substrate 100, and radiates the heat generated by the control IC 101 and the like. The heat radiating plate 700 is made of copper, aluminum, or the like, which are materials with high thermal conductivity.

The external terminal substrate 200 is made of a rigid printed wiring board, and is fixed to the holding metal plate 300 attached to the base member 400 with screws 201 and 202. The external terminal substrate 200 includes an external connection terminal 203 and a connector 204. The external connection terminal 203 is, for example, an HDMI terminal such as an HDMI type-A terminal, and is soldered to the external terminal substrate 200. The external terminal substrate 200 is provided parallel to a substrate surface of the control substrate 100. The connectors 104 and 204 are engaged with each other, and a signal from the external connection terminal 203 is sent to the control IC 101. The control substrate 100 and the external connection terminal 203 are arranged in a position where they overlap each other in the thickness direction of the control substrate 100 (front-rear direction, direction orthogonal to the substrate surface). The external terminal substrate 200 in the front-rear direction with respect to the control substrate 100 is positioned by the connectors 104 and 204. By changing the heights of the connectors 104 and 204, the position of the external connection terminal 203 can be changed, the arrangement with other components inside the image pickup apparatus 10 can be adjusted, and the thickness of the image pickup apparatus 10 in the front-rear direction can be reduced.

The connectors 104 and 204 are in a relationship of a plug connector and a receptacle connector whose engagement shapes are compatible with each other. The connectors 104 and 204 are configured as floating connectors. The floating connector is a connector in which the terminal constituting the connector includes a spring and is movable in a substrate plane direction (direction parallel to the substrate surface). Here, movement includes linear movement and rotational movement. Since the connectors 104 and 204 are movable, they can maintain electrical connection, absorb errors and misalignment during the engagement, and suppress defects such as their breakages. While the connectors 104 and 204 are movable in the substrate plane direction, the external terminal substrate 200 is positioned on the holding metal plate 300 and fixed with screws 201 and 202. Each of the control substrate 100 and the external terminal substrate 200 is positioned on the base member 400 and the holding metal plate 300, respectively, and a positional shift between the connectors 104 and 204 is absorbed by the floating connector configuration.

The rear cover unit 500 is fixed to the base member 400 by screws fastened to the base member 400 by a metal plate 502 which is screwed to the rear cover 501.

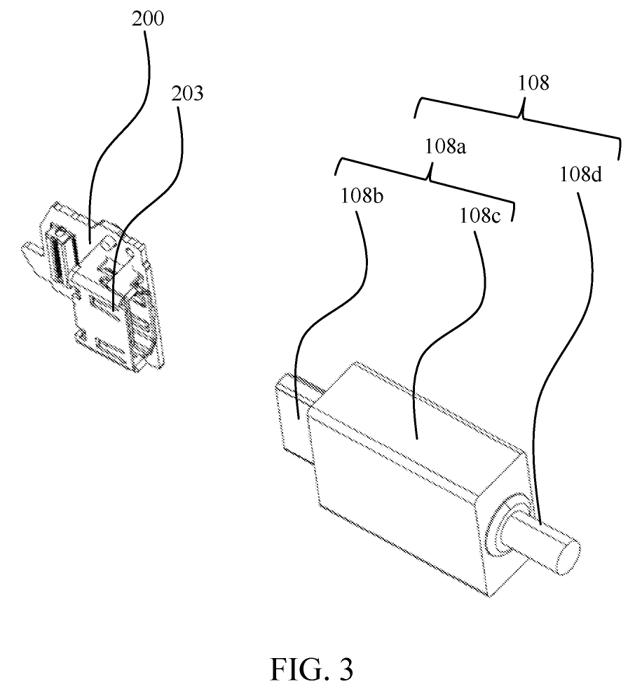

FIG. 3 is a perspective view of a connection cable 108 to an unillustrated external device. The connection cable 108 includes a cable portion 108d and a plug 108a provided at the end. The plug 108a is provided at the tip and includes a protruding connector 108b and a grip portion 108c. By inserting the connector 108b into the external connection terminal 203, the image pickup apparatus 10 and the external device can be electrically connected.

While the image pickup apparatus 10 and the external device are connected via the connection cable 108, the user operates each device and performs various tasks. In a case where an error occurs during the task, such as catching the connection cable 108, a large external force may be momentarily applied to the connection cable 108. In a case where the external force is applied to the connection cable 108, the external connection terminal 203 also receives the external force, which may cause damage to the solder joint portion with the external terminal substrate 200 or breakage or deformation of the external connection terminal 203 itself. As a result, the image pickup apparatus 10 cannot be connected to the external device.

In this embodiment, in order to suppress damage to the solder joint portion with the external terminal substrate 200 or damage or deformation of the external connection terminal 203 itself, a restricting portion is provided for restricting the external terminal substrate 200 from moving in each direction. For example, a restricting portion may be provided for restricting the external terminal substrate 200 from moving when the external connection terminal 203 receives an external force in a direction orthogonal to the substrate surface of the control substrate 100. A restricting portion may be provided for restricting the external terminal substrate 200 from moving when the external connection terminal 203 receives an external force in a direction parallel to the gravity direction. A specific configuration of the restricting portion will now be described.

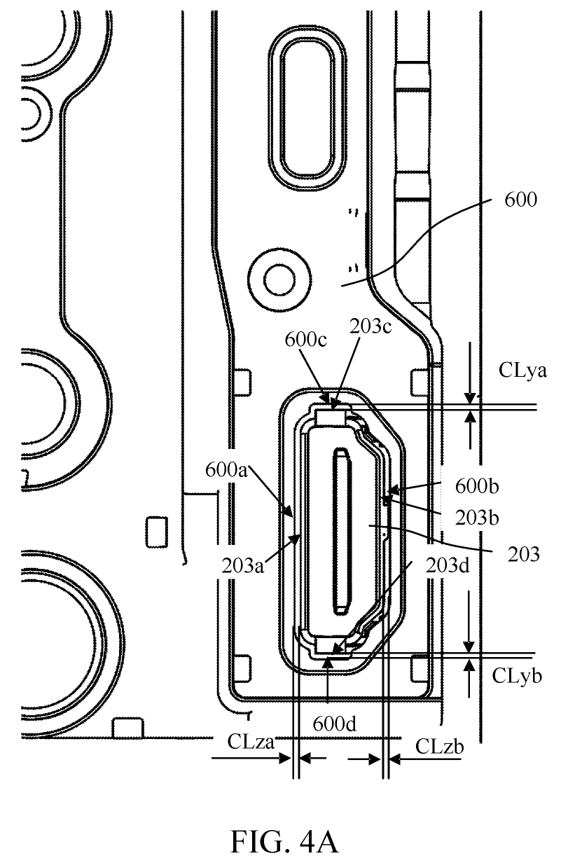

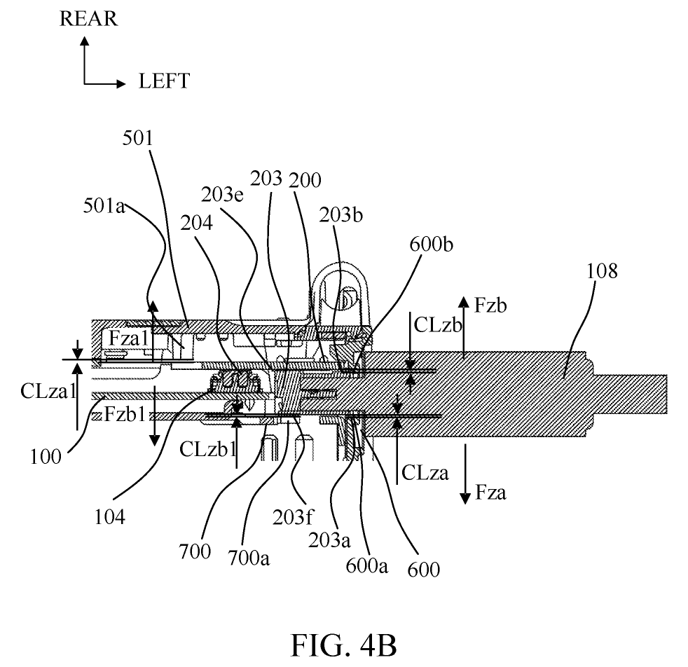

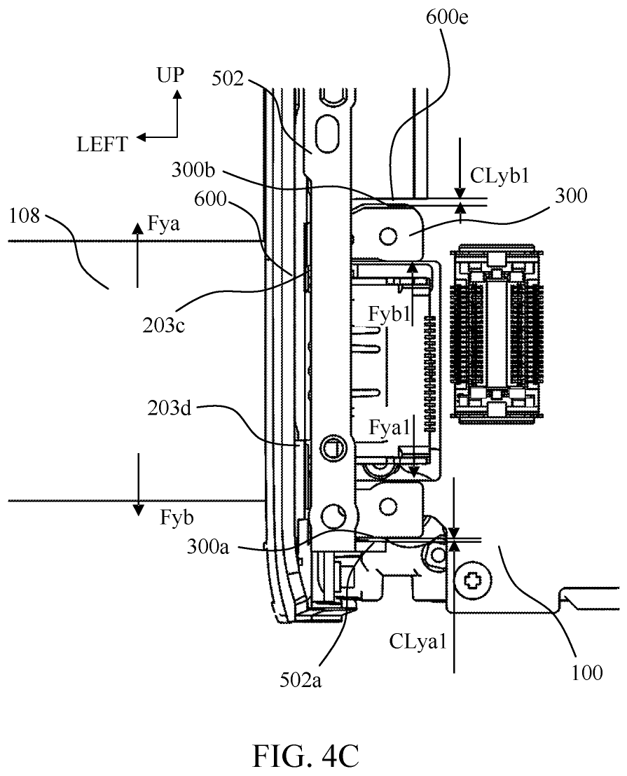

FIGS. 4A, 4B, and 4C explain the image pickup apparatus 10. FIG. 4A is an enlarged view of the side surface of the image pickup apparatus 10, illustrating clearance in each direction between the side cover 600 having an opening for exposing the external connection terminal 203, and the external connection terminal 203. CLza is clearance (gap or space) between the external connection terminal 203 and a front portion 600a of the opening of the side cover 600. CLzb is clearance between the external connection terminal 203 and a rear portion 600b of the opening of the side cover 600. CLya is clearance between the external connection terminal 203 and an upper portion 600c of the opening of the side cover 600. CLYb is clearance between the external connection terminal 203 and a lower portion 600d of the opening of the side cover 600. In this embodiment, the relatively small external terminal substrate 200 mounted with the external connection terminal 203 is positioned on the holding metal plate 300 as described above. Therefore, it is possible to precisely align the positions of the front portion 600a, rear portion 600b, upper portion 600c, and lower portion 600d of the opening of the side cover 600 with the external connection terminal 203 without being affected by substrate warpage or the like. Therefore, the clearances CLza, CLzb, CLya, and CLyb between the external connection terminal 203 and each portion of the opening of the side cover 600 can be uniformly set.

Referring now to FIGS. 4A and 4B, a description will be given of a case where external force Fza acts on the external connection terminal 203 on the front side of the image pickup apparatus 10. FIG. 4B is a sectional view of the principal parts of the external terminal substrate 200 and the external connection terminal 203. By using a front position 203a of the external connection terminal 203 as a fulcrum, force Fza1 acts in a direction in which a rear terminal 203e of the external connection terminal 203 is pressed against the external terminal substrate 200. The force Fza1 similarly acts on the external terminal substrate 200, and the connector 204 of the external terminal substrate 200 moves in a direction in which it floats up from the connector 104 of the control substrate 100. In order to suppress the destruction and deformation of the external connection terminal 203 and to suppress the floating up of the connectors 104 and 204 to maintain the electrical connection, a receiving portion (first restricting portion) 501a is provided to the rear cover 501. That is, the external terminal substrate 200 and the receiving portion 501a may be arranged as close as possible to each other. In this embodiment, clearance CLza1 between the external terminal substrate 200 and the receiving portion 501a is set to be smaller than the clearance CLza between the external connection terminal 203 and the front portion 600a of the opening in the side cover 600. By setting it in this manner, when the external force Fza acts on the external connection terminal 203 on the front side of the image pickup apparatus 10, the external terminal substrate 200 can be received by the receiving portion 501a. This structure can restrain the external connection terminal 203 from coming into contact with the front portion 600a of the opening in the side cover 600 to apply the external force directly to the external connection terminal 203, and from peeling off from the external terminal substrate 200.

Referring now to FIGS. 4A and 4B, a description will be given of a case where external force Fzb acts on the external connection terminal 203 on the rear side of the image pickup apparatus 10. By using a rear position 203b of the external connection terminal 203 as a fulcrum, force Fzb1 acts in a direction in which the rear terminal 203e of the external connection terminal 203 floats up from the external terminal substrate 200. Force Fzb1 similarly acts on the external terminal substrate 200, and the connector 204 of the external terminal substrate 200 moves in a direction in which it is pressed against the connector 104 of the control substrate 100. In order to suppress breakage and deformation of the external connection terminal 203, a receiving portion (second restricting portion) 700a of the heat radiating plate 700 is provided at a position that suppresses floating up of the rear terminal 203e of the external connection terminal 203. That is, a surface 203f (part of the external connection terminal 203) that is difficult to peel off from the external terminal substrate 200 even when an external force acts on the external connection terminal 203 and the receiving portion 700a may be arranged as close as possible to each other. In this embodiment, clearance CLzb1 between the surface 203f and the receiving portion 700a is set to be smaller than the clearance CLzb between another part of the external connection terminal 203 and the rear portion 600b of the opening provided in the side cover 600. By setting it in this manner, when the external force Fzb acts on the external connection terminal 203 on the rear side of the image pickup apparatus 10, the surface 203f can be received by the receiving portion 700a. Therefore, this structure can restrain the external connection terminal 203 from coming into contact with the rear portion 600b of the opening in the side cover 600 when an external force acts on the external connection terminal 203 to apply the external force to a portion that is easy to peel off from the external terminal substrate 200, and from peeling off from the external terminal substrate 200.

Referring now to FIGS. 4A and 4C, a description will be given of a case where external force Fya acts on the external connection terminal 203 on the upper side of the image pickup apparatus 10. Force Fya1 acts in a rotating direction about the upper position 203c of the external connection terminal 203 as a center. The force Fya1 similarly acts on the external terminal substrate 200, and the connector 204 of the external terminal substrate 200 rotates in a direction of the force Fya1 relative to the connector 104 of the control substrate 100. In order to suppress breakage and deformation of the external connection terminal 203 and to maintain the electrical connection by suppressing the rotation of the connectors 104 and 204, a receiving portion (third restricting portion) 502a of the metal plate 502 is provided at a position that suppresses the rotation of the external connection terminal 203. That is, the receiving portion 502a and the receiving portion (first receiving portion) 300a provided on the side surface of the holding metal plate 300 may be arranged as close as possible to each other. In this embodiment, clearance CLya1 between the receiving portions 300a and 502a is set to be smaller than the clearance CLya between the external connection terminal 203 and the upper portion 600c of the opening in the side cover 600. The clearance CLya1 is also set to be smaller than a moving amount of each of the connectors 104 and 204. By setting it in this manner, when external force Fya acts on the external connection terminal 203 on the upper side of the image pickup apparatus 10, the receiving portion 300a can be received by the receiving portion 502a. Therefore, this structure can restrain the external connection terminal 203 from coming into contact with the upper portion 600c of the opening in the side cover 600 to apply the external force directly to the external connection terminal 203, and from peeling off from the external terminal substrate 200.

Referring now to FIGS. 4A and 4C, a description will be given of a case where external force Fyb acts on the external connection terminal 203 on the lower side of the image pickup apparatus 10 (in the gravity direction). The force Fyb1 acts in a rotating direction about the lower position 203d of the external connection terminal 203 as a center. The force Fyb1 similarly acts on the external terminal substrate 200, and the connector 204 of the external terminal substrate 200 rotates in the direction of the force Fyb1 relative to the connector 104 of the control substrate 100. In order to suppress breakage and deformation of the external connection terminal 203 and to maintain the electrical connection by suppressing the rotation of each of the connectors 104 and 204, a receiving portion (fourth restricting portion) 600e of the side cover 600 is provided at a position that suppresses the rotation of the external connection terminal 203. That is, the receiving portion 600e and the receiving portion (second receiving portion) 300b provided on the side surface of the holding metal plate 300 may be arranged as close as possible to each other. In this embodiment, clearance Clyb1 between the receiving portions 300b and 600e is set to be smaller than the clearance Clyb between the external connection terminal 203 and the lower portion 600d of the opening in the side cover 600. In addition, Clyb1 is set to be smaller than a moving amount of each of the connectors 104 and 204. By setting it in this manner, when external force Fyb acts on the external connection terminal 203 on the lower side of the image pickup apparatus 10, the receiving portion 300b can be received by the receiving portion 600e. Therefore, this structure can restrain the external connection terminal 203 from coming into contact with the lower portion 600d of the opening in the side cover 600 to apply the external force directly to the external connection terminal 203, and from peeling off from the external terminal substrate 200.

In this embodiment, the side surface of the holding metal plate 300 and the side cover 600 are arranged as close as possible to each other, but a similar effect can be obtained by bringing the side surface of the external terminal substrate 200 and the side cover 600 closer to each other. However, in this structure, a load is applied directly to the external terminal substrate 200, and thus a design needs to consider damage to the wiring inside the external terminal substrate 200 and debris generated by peeling off of the external terminal substrate 200.

As discussed above, in this embodiment, the external connection terminal 203 is mounted on the external terminal substrate 200, which is a substrate separate from the control substrate 100, and the external connection terminal 203 is positioned so as to overlap the control substrate 100 in a direction orthogonal to the substrate surface. Thereby, the position of the external connection terminal 203 can be freely designed, and the size of the image pickup apparatus 10 can be reduced.

While the disclosure has described example embodiments, it is to be understood that the disclosure is not limited to the example embodiments. The scope of the following claims is to be accorded the broadest interpretation so as to encompass all such modifications and equivalent structures and functions.

This embodiment can provide a compact electronic apparatus.

This application claims priority to Japanese Patent Application No. 2024-091959, which was filed on June 6, 2024, and which is hereby incorporated by reference herein in its entirety.

What is claimed is:

1. An electronic apparatus comprising:
a first substrate including a first connector and fixed to a first fixed member; and
a second substrate including a second connector connected to the first connector and a terminal connectable to an external device, and the second substrate being fixed to a second fixed member different from the first fixed member so that the second substrate is parallel to a substrate surface of the first substrate,
wherein the terminal overlaps the first substrate in a direction orthogonal to the substrate surface.

2. The electronic apparatus according to claim 1, wherein each of the first connector and the second connector has transitioned from a pre-connection state to a state in which each of the first connector and the second connector moved relative to each other in a direction parallel to the substrate surface.

3. The electronic apparatus according to claim 1, further comprising at least one restricting portion for restricting the second substrate from moving when the terminal receives an external force.

4. The electronic apparatus according to claim 3, wherein the at least one restricting portion includes a first restricting portion that comes into contact with the second substrate when the terminal receives the external force and restricts the second substrate from moving, and
wherein clearance between the second substrate and the first restricting portion is smaller than clearance between the terminal and an opening provided in an exterior member for exposing the terminal to outside.

5. The electronic apparatus according to claim 4, wherein the first restricting portion is provided to a rear cover, and
wherein the exterior member is a side cover.

6. The electronic apparatus according to claim 3, wherein the at least one restricting portion includes a second restricting portion that comes into contact with a portion of the terminal when the terminal receives the external force and restricts the second substrate from moving, and
wherein clearance between the portion of the terminal and the second restricting portion is smaller than clearance between another portion of the terminal and an opening provided in an exterior member for exposing the terminal to outside.

7. The electronic apparatus according to claim 6, wherein the second restricting portion is provided to a heat radiating plate, and
wherein the exterior member is a side cover.

8. The electronic apparatus according to claim 3, wherein the at least one restricting portion includes a third restricting portion that comes into contact with a first receiving portion provided to the second fixed member when the terminal receives the external force and restricts the second substrate from moving, and
wherein clearance between the first receiving portion and the third restricting portion is smaller than clearance between the terminal and an opening provided in an exterior member for exposing the terminal to outside.

9. The electronic apparatus according to claim 8, wherein the third restricting portion is provided to a metal plate, and
wherein the exterior member is a side cover.

10. The electronic apparatus according to claim 3, wherein the at least one restricting portion includes a fourth restricting portion that comes into contact with a second receiving portion provided to the second fixed member when the terminal receives the external force, and restricts the second substrate from moving, and
wherein clearance between the second receiving portion and the fourth restricting portion is smaller than clearance between the terminal and an opening provided in an exterior member for exposing the terminal to outside.

11. The electronic apparatus according to claim 10, wherein the fourth restricting portion is provided to the exterior member, and
wherein the exterior member is a side cover.

12. The electronic apparatus according to claim 3, wherein the at least one restricting portion includes a restricting portion for restricting the second substrate from moving when the terminal receives external force in a direction orthogonal to the substrate surface.

13. The electronic apparatus according to claim 3, wherein the at least one restricting portion includes a restricting portion that restricts the second substrate from moving when the terminal receives external force in a direction parallel to a gravity direction.

14. The electronic apparatus according to claim 1, wherein the electronic apparatus is an image pickup apparatus.

15. The electronic apparatus according to claim 1, wherein the terminal is an HDMI terminal.
